(19) United States
(12) Patent Application Publication
(10) Pub. No.: US 2006/0269901 A1
(43) Pub. Date: Nov. 30, 2006

(54) Dental instruments having durable coatings

(75) Inventors: Ken Rosenblood, Los Angeles, CA (US); Nancy N. Quan, North Hills, CA (US)

Correspondence Address: DISCUS DENTAL IMPRESSIONS, INC., 8550 HIGUERA STREET, CULVER CITY, CA, 90232, US

(73) Assignee: Discus Dental Impressions, Inc.

(21) Appl. No.: 11/230,605

(22) Filed: Sep. 19, 2005

Related U.S. Application Data
(60) Provisional application No. 60/612,283, filed on Sep. 21, 2004.
(60) Provisional application No. 60/612,006, filed on Sep. 21, 2004.
(60) Provisional application No. 60/624,840, filed on Nov. 3, 2004.
(60) Provisional application No. 60/624,833, filed on Nov. 3, 2004.

(51) Int. Cl. A61C 3/06

(52) U.S. Cl. 433/166; 433/119

(57) ABSTRACT

The present invention relates to dental instruments used in tooth restoration and replacement including dental burs, dental discs, tapes, endodontic files, surgical drills and taps, having abrading working surfaces coated or embedded with diamond particles or chips onto the substrate or shank, the abrading surfaces having a flexible diamond-like carbon (DLC) coating. The substrate may be flexible or the shank may be made of a relatively hard substrate and diamond particles or chips may be coated or embedded onto the substrate or shank through the use of polymeric bonding agents, through embedding in a nickel or nickel alloy matrix, or through chemical vapor deposition, or even direct coating if polymeric substrates are used. The abrading surface may also be formed through the formation of cutting edges or surfaces on the substrate. The present invention further relates to a dental tip, which may be part of an ultrasonic dental insert may be made of a metallic or polymeric substrate which is coated with a flexible and durable coating. The coated tip is bent or can be bent to a desired configuration. The coating is made of a diamond-like-carbon (DLC) coating having at least about 5 atomic percent of hydrogen. The coated abrading surfaces or tips are longer lasting than uncoated surfaces and the coating may also serve as a wear indicator. Further, the coating is present on the surface of the bur or tip during use without obstructing the abrasive function of the dental instruments.

### CROSS-REFERENCE TO RELATED APPLICATIONS

This application claims the benefit of U.S. Provisional patent applications: Ser. No. 60/612,283 entitled “Dental Tool Having A Durable Coating” filed on Sep. 21, 2004; 60/612,006 entitled “Dental Instruments Having Durable Coatings” filed Sep. 21, 2004; 60/624,833 entitled, “Dental Instrument” filed on Nov. 3, 2004; and 60/624,840 entitled, “Dental Instruments With Stress Relief” filed on Nov. 3, 2004.

This application is related to the following U.S. patent applications: 11/______, entitled “Dental Instrument With Stress Relief” to be concurrently filed; and 11/______, entitled “Dental Instrument” to be concurrently filed.

### FIELD OF THE INVENTION

This invention relates to dental instruments in general. Specifically, this invention relates to dental instruments having a durable coating.

### BACKGROUND OF THE INVENTION

During dental restoration, a dentist removes and/or repairs a person's tooth that is badly damaged either by decay or injury. If the tooth is to be repaired, the dentist removes the damaged portions and the cavity formed is filled with an amalgam or occlusal composite resin to restore the tooth. Once filled, the amalgam or composite resin is hardened, and the restored tooth is shaped to resemble the original form as closely as possible. Tooth restoration not only restores missing tooth structures, but is also done to enhance aesthetics and preserve function. Rotary dental instruments play an essential part in such restorative work and have been in use since the 1940's.

Dental practitioners also use dental tools (instruments) for dental treatments and procedures, such as scaling, periodontal treatments, root canal therapy, and the like. These tools may also lose their cutting efficiency over time. Any coating that will either increase the useful life of a tool and/or change color to indicate the wear is desirable.

Many different ways have been proposed in the art for extending the usable life of a bur in the art. One way is by coating a thin layer of a metallic nitride, like titanium nitride, using vacuum deposition, as disclosed in U.S. Pat. No. 4,681,541. Thicknesses of up to 1 mil have been proposed to, cover the diamond particles. However, since the surface is irregular, as most abrading surfaces are, the coating will soon be eroded through where it coats the particles, and the diamond particles become the working surface and only the matrix between the particles will be protected by the coating.

Another method is the selection of different designs of cutting surfaces and the angles between them to improve the life of the working surfaces.

A further way is through the treatment of diamond particles to enable them to be metallurgically bonded to the substrate, such as disclosed in U.S. Pat. No. 5,277,940. This in some manner decreased the loss of particles from the working surface.

In addition, even though instruments mentioned perform cutting and abrading functions, the abrading surfaces formed with embedded diamond chips are prone to dislodgement. Protective coatings coated over such abrading surfaces have been proposed to keep the chips from becoming dislodged during packaging, shipping, general handling and sterilization. A tough polymer coating used for this purpose is disclosed in U.S. Pat. No. 6,722,883. Such a coating is designed to roll back from the cutting surface upon contact of the dental bur with a tooth or ceramic material used in restoratives. Thus, the coating does not contribute to the cutting performance of the burs during use.

There remains a need for a coating for a dental instrument, such as a scaler, a bur, a disc or tape, an endodontic file, a surgical drill and tap, that not only protects the abrading or cutting surfaces during packaging, shipping, general handling and sterilization, but also contributes to their wear resistance during use and serves to indicate wear of the working surface, regardless of the design of the cutting surfaces.

### SUMMARY OF THE INVENTION

The present invention relates to dental instruments having a flexible coating that is durable, capable of increasing the useful life of an instrument or tool, and/or also useful in indicating the wear of the working portion of the instrument/tool.

In one embodiment of the present invention, there are disclosed dental instruments used in tooth restoration and replacement including dental burs, dental discs, tapes and others having abrading working surfaces coated or embedded with diamond particles or chips onto the substrate or shank, the abrading surfaces having a flexible diamond-like carbon (DLC) coating. The shank or substrate may be made of a relatively hard and/or a relatively flexible substrate, and the diamond particles or chips may be coated onto or embedded into the shank or substrate through the use of polymeric bonding agents, through embedding in a nickel or nickel alloy matrix, through chemical vapor deposition or combinations thereof. The coated abrading surfaces are longer lasting than uncoated surfaces and the coating may also serve as a wear indicator. Further, the coating is present on the surface of the bur during use without obstructing the abrasive function of the burs.

In another embodiment of the invention, the abrading surfaces of rotary dental burs, discs, tapes, surgical drills, endodontic files and taps include cutting surfaces formed on the working surface portion of the shank or substrate. The cutting surfaces have flexible coatings including diamond-like carbon coating. The coating is present on the cutting surfaces of the instruments during use without interfering with the abrasive function of the instruments.

In one aspect of the invention, the diamond-like carbon coating may be applied at temperatures that do not substantially adversely affect the substrate, or the bonding agent or matrix used for coating or embedding diamond chips. The diamond-like carbon coating may be applied using methods including laser ablation; ion-beam assisted deposition; and radio-frequency plasma deposition.

In another aspect of the invention, the rotary dental bur includes a non-abrasive shank portion adapted to be held by a dental drill and an abrading working portion coated with diamond chips or having cutting edges formed thereon, connecting to and extending downwardly from the shank portion, the abrading portion includes a diamond-like carbon coating that is different in color from the non-abrading shank such that the color change anywhere on the abrading portion may act as a wear indicator of the abrading portion.

In still another aspect of the invention, the rotary dental bur includes a non-abrasive shank portion adapted to be held by a dental drill and an abrading working portion coated or embedded with diamond chips or having cutting edges formed thereon, connecting to and extending downwardly from the shank portion, the abrading portion includes a diamond-like carbon coating that is different in color from the non-abrading shank and the underlining abrading working portion coated with diamond chips such that when the color of the underlying abrading working portion becomes visible, it acts as a wear indicator of the abrading portion.

In a further aspect of the invention, a rotary dental bur including a non-abrasive shank portion adapted to be held by a dental drill and an abrading working portion including a flexible diamond-like carbon coating that closely follows the contours of the abrading portion is disclosed. The substrate remains substantially covered by the coating during use.

In yet another aspect of the invention, an abrading disc including a flexible substrate adapted for mounting onto a driver and having diamond particles coated or embedded or having cutting edges formed thereon the surface of the substrate, the abrading surface is coated with a flexible diamond-like coating that substantially covers the abrading surface during use. The substrate can be flexible and the abrading disc having a flexible coating including a diamond-like carbon (DLC) coating may be bent or twisted without damage to the integrity of the coating.

In still yet another aspect of the invention, an abrading tape including a flexible substrate having diamond particles coated or embedded or having cutting edges formed thereon, the abrading surface is coated with a flexible diamond-like coating that substantially covers the abrading surface during use. The substrate can be flexible and the abrading tape having a flexible coating including a diamond-like carbon (DLC) coating may be bent or twisted without damage to the integrity of the coating, to expose the diamond particles, leading to better retention of the particles and longer lasting abrading surfaces.

In a further embodiment of the present invention, a dental tip including a substrate shank having a flexible and durable coating coated thereon, such that the coated tip may be bent to the desired configuration, is disclosed. The coating includes a diamond-like-carbon (DLC) coating including at least about 5 atomic percent of hydrogen.

In one aspect, the tip may be bent to any desired configuration after coating, such bending action does not substantially affect the integrity of the coating adversely. The tip may be part of an ultrasonic dental insert including a proximal end, and a distal end having the tip attached thereto. The ultrasonic dental insert may also be inserted into a handpiece having a polymeric hand grip attached thereon.

In another aspect, the tip may also be present on a perioscope or other visual aid used in the vicinity of the ultrasonic tip and thus will encounter ultrasonic energy, even if indirectly.

In a further aspect, the tip may be part of a vibratory, handheld dental instrument including an elongated housing having a hollow interior, a distal end and a proximal end.

In yet another exemplary embodiment of the present invention, an ultrasonic dental hand insert including a proximal end, and a distal end having a tip attached thereto, a polymeric hand grip covering a portion of the insert close to the distal end of the insert, said tip including a substrate shank having a flexible and durable coating coated thereon at least a portion of said substrate after the insert and hand grip are assembled. The coating may include a diamond-like-carbon coating including at least about 5 atomic percent of hydrogen. The tip may either be bent prior to or after the coating is applied. The flexible coating can follow the contour of the tip. The diamond-like coating includes amorphous atomic structures, microcrystalline atomic structures or combinations thereof with at least about 5 atomic percent of hydrogen. This coating exhibits good hardness, high lubricity and high flexibility so that any flexing of the instrument, for example, will not result in stress cracking of the DLC coating layer.

In addition to the above, the tip may also be present on other vibratory instruments including an instrument having at least one vibrator module positioned inside the housing of the instrument towards. The module has a small motor adapted to rotate an eccentric weight to cause a vibration in the tip. A battery is positioned inside the housing to power the vibrator module to excite the vibratory element. The battery may be disposable or rechargeable.

The present invention also relates to a method of producing an ultrasonic dental insert having a polymeric hand grip and a tip having a flexible and durable coating coated thereon is disclosed. In one aspect, the method includes:

assembling an insert having a tip at its distal end and a polymeric hand grip covering portions of the insert close to the distal end; and

coating at least a portion of the substrate of the tip with a flexible and durable coating at a temperature that does not substantially affect the integrity of the hand grip;

wherein the coating includes a diamond-like-carbon coating including at least about 5 atomic percent hydrogen.

In another aspect, a method of producing an ultrasonic dental insert including a bent tip having a flexible and durable coating coated thereon is disclosed. The method includes:

assembling an insert having a tip at its distal end; coating at least a portion of the tip with a flexible, durable coating; and

bending the tip to any desired configuration;

wherein the coating includes a diamond-like-carbon coating including at least about 5 atomic percent hydrogen.

In yet a further embodiment of the present invention, a colored flexible and durable coating is present on the tip of an ultrasonic insert that is different in color from the bare substrate including the tip, such that the change in color of the tip serves as a wear indicator.

### BRIEF DESCRIPTION OF THE FIGS.

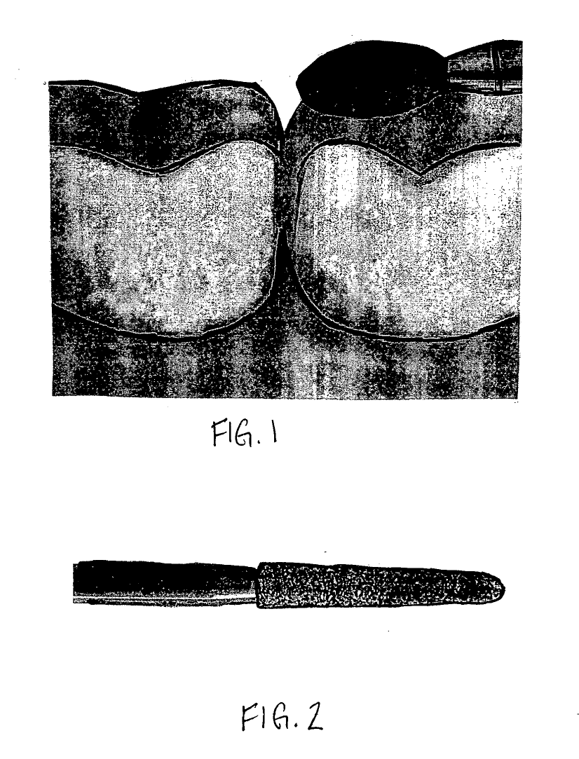

FIG. 1 shows an exemplary rotary dental instrument;

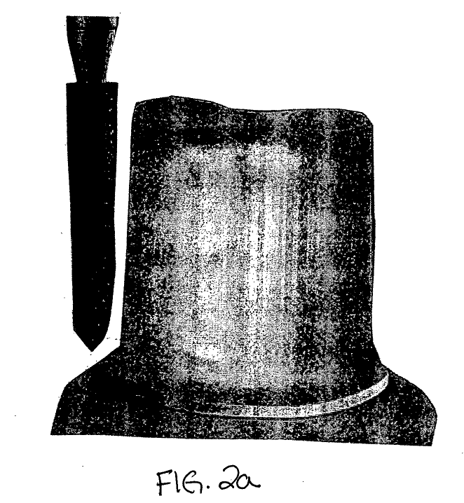

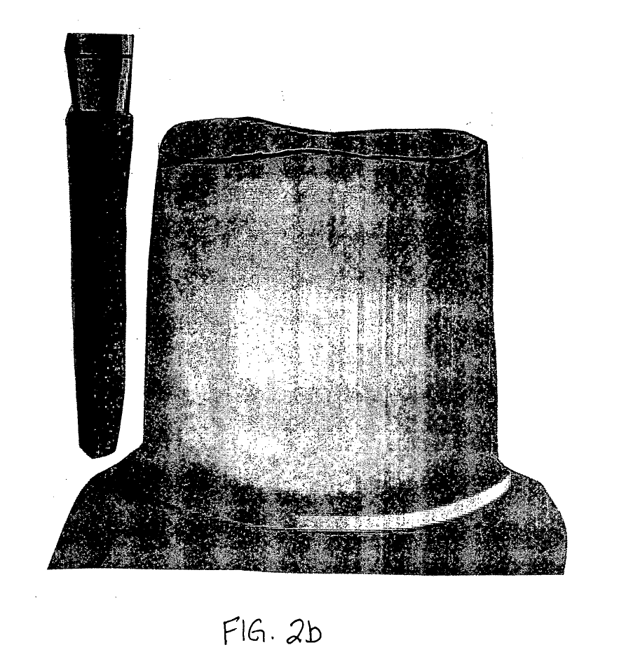

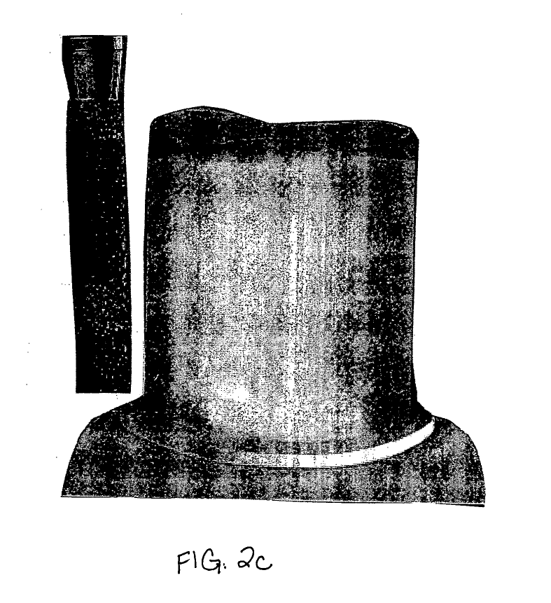

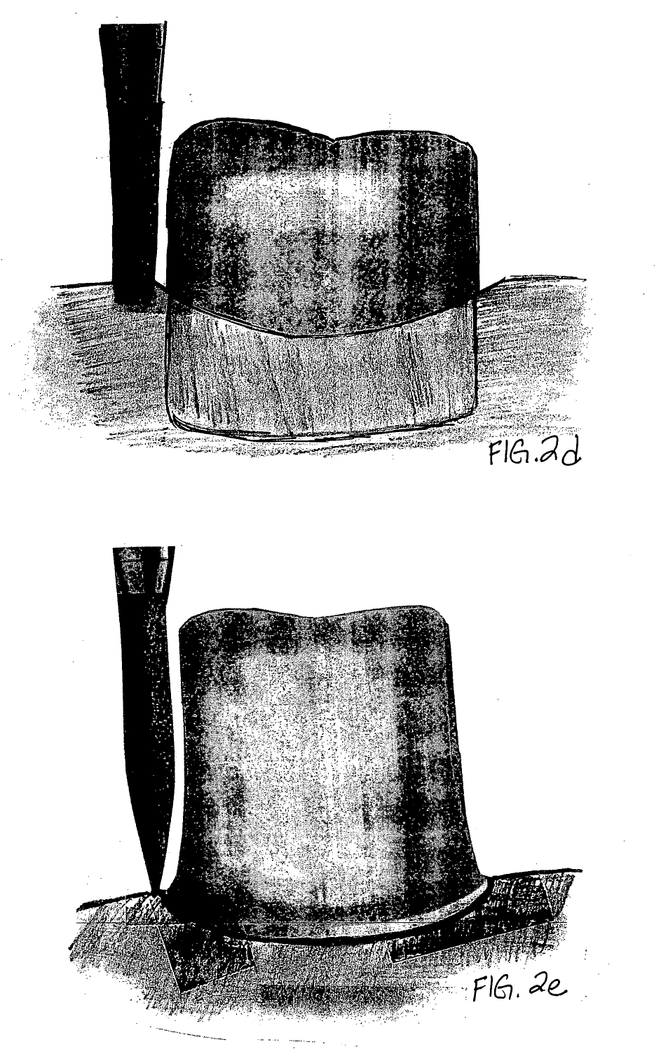

FIG. 2 shows an example of a diamond bur;

FIGS. 2a-f are examples of various shapes and grit sizes of diamond burs;

FIGS. 3a and b are examples of carbide burs;

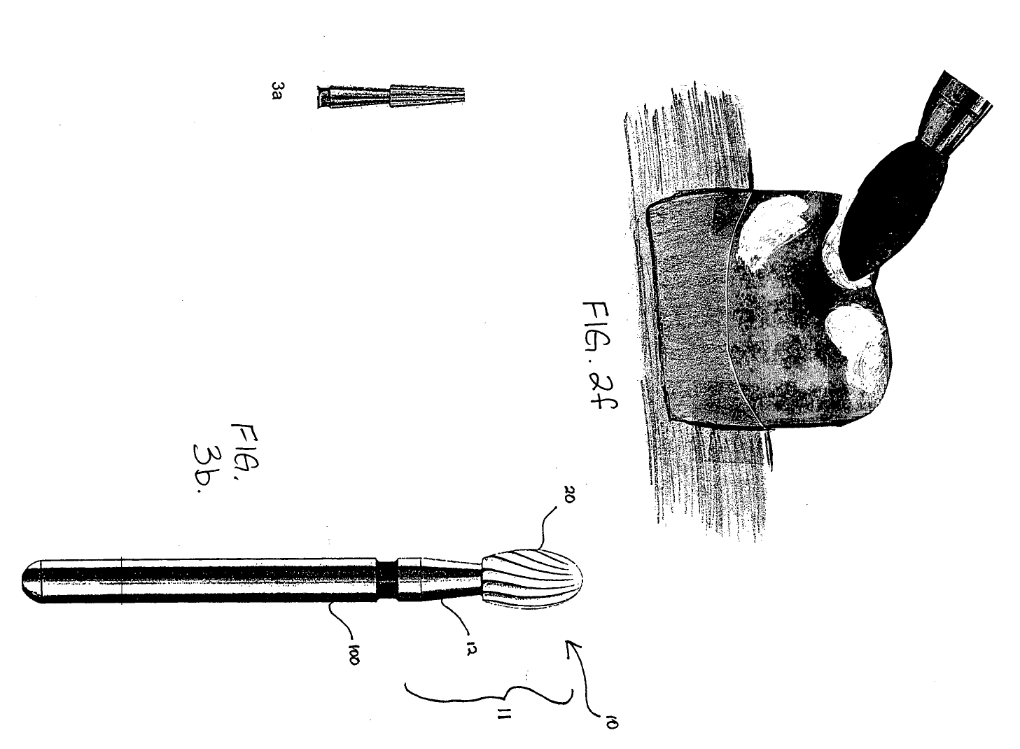

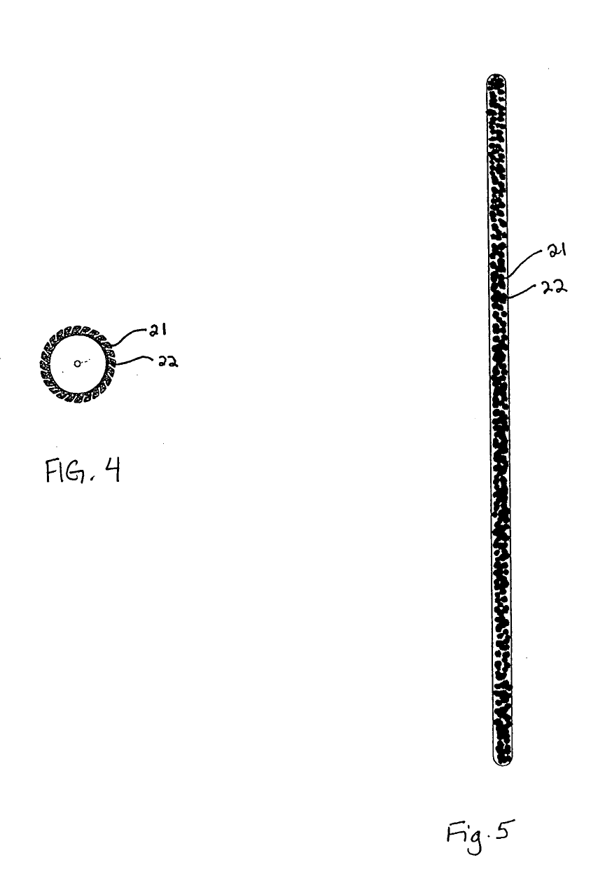

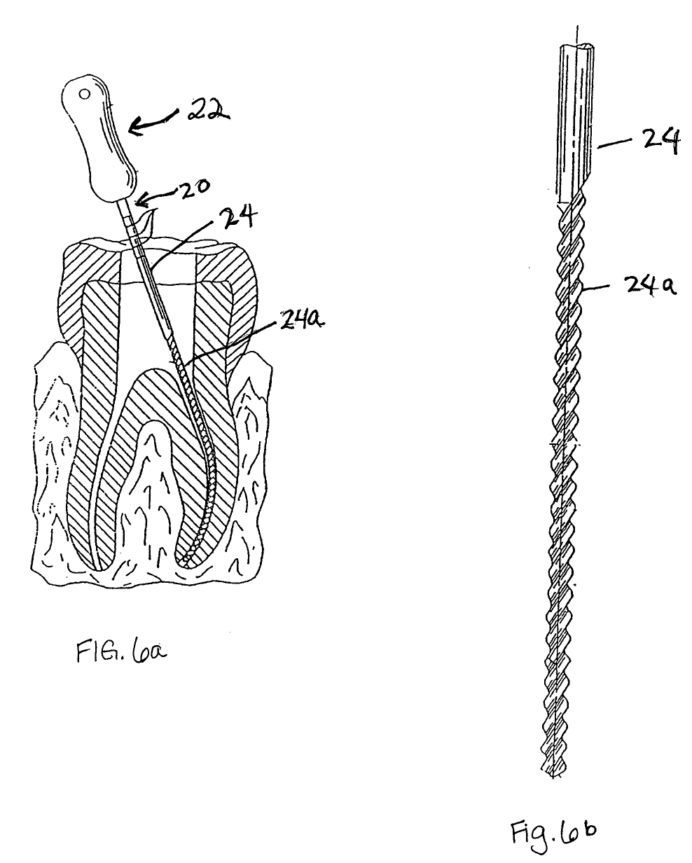

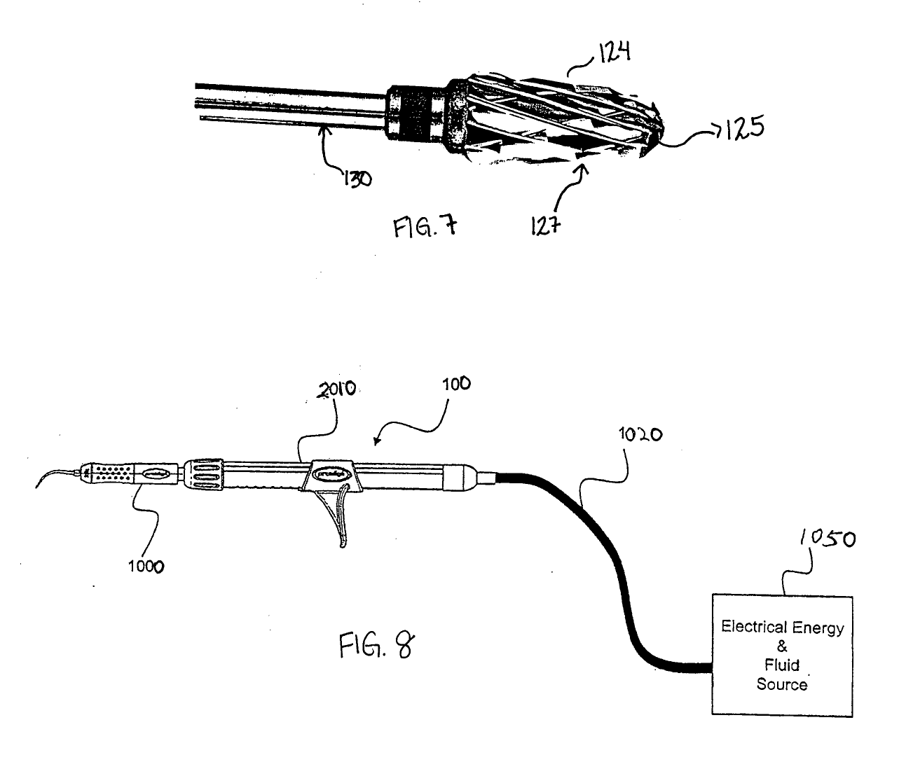

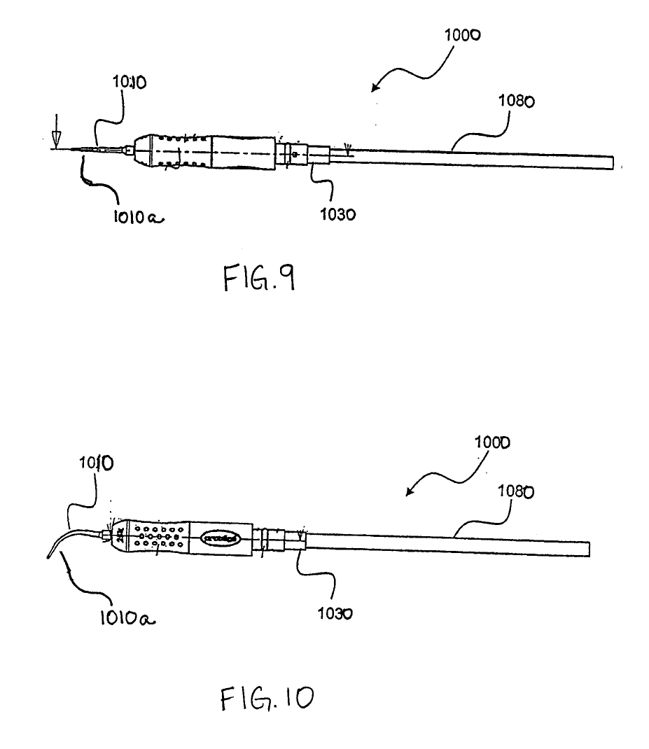

FIG. 4 shows an exemplary abrading disc;

FIG. 5 shows an exemplary abrading tape;

FIG. 6a and b show an exemplary endodontic file;

FIG. 7 shows an exemplary dental drill;

FIG. 8 shows an ultrasonic dental unit (or system) including an ultrasonic dental tool attached to an electrical energy & fluid source;

FIG. 9 is a top view of a dental tool insert having a coated tip in an exemplary embodiment of the present invention;

FIG. 10 illustrates the tip of FIG. 2, which has been bent;

FIG. 10a shows an active dental instrument according to one embodiment of the invention;

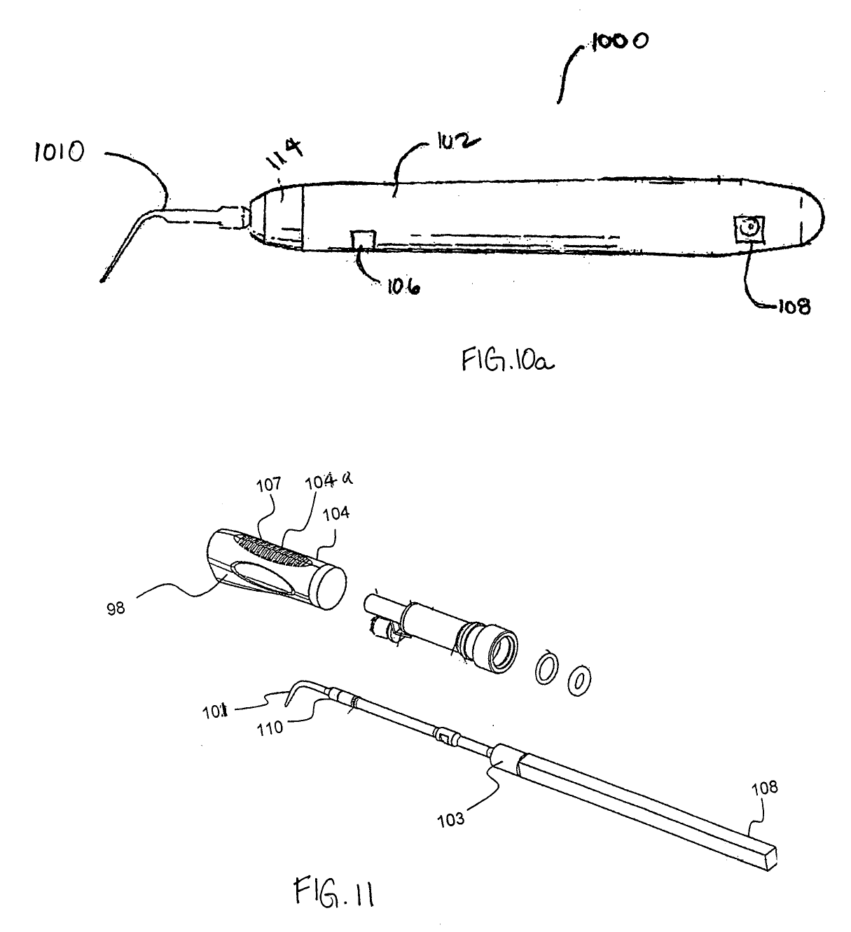

FIG. 11 illustrates a dental insert having a polymeric hand grip in an exemplary embodiment of the present invention;

FIG. 12 illustrates a dental insert having a hand grip in the form of a pistol grip; and

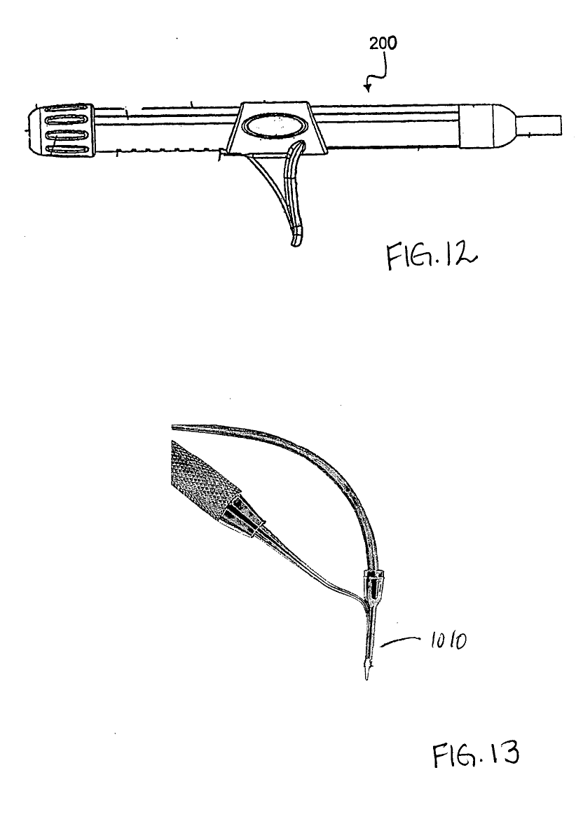

FIG. 13 illustrates an exemplary perioscope.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the steps for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

Dental professionals as used herein include dentists, dental hygienists, dental laboratory technicians and others involved in the restorative or cleaning processes.

Dental instruments as used herein include ultrasonic dental tools, other vibratory dental tools, rotary instruments, abrading instruments, and other cutting tools for surgical placements of dental and orthopedic implants, including dental scalers, vibratory scalers, ultrasonic dental scalers, periscopes used in conjunction or in the vicinity of an ultrasonic dental scaler and others; rotary dental burs such as dental multi-use diamond burs, dental carbide burs, dental sintered diamond burs, and dental steel burs; dental diamond discs; dental laboratory tungsten carbide cutters; endodontic files; surgical drills; taps; and tapes having durable coatings. These instruments are all contemplated in the present invention.

Some of these instruments are developed to aid dental professionals in removing damaged portions of the tooth, including root canals, reconstructing and shaping the restored tooth or replacement tooth, including dental implants. Other instruments include those developed to aid dental professionals in teeth cleaning, plaque removal and other periodontal presses.

Composite resins or ceramic restoratives are commonly used, whether the restorative work is preformed for aesthetic and/or functional reasons. Since these ceramics are generally as hard as porcelain when they are ready to be sculpted, rotary dental tools such as diamond coated burs or carbide burs are generally used for such sculpting, as well as abrading discs and tapes. The working surfaces are usually coated or embedded with abrasive particles such as diamond chips or crystals. When embedding or coating, a generally soft substrate is used. When the substrate erodes, the diamond crystals are lost and the bur can no longer perform its function. These tools thus tend to wear out quite quickly and have to be replaced. Both the removal and shaping processes in this restoration process contribute to the wear of the instruments. Since the removal process takes longer with moderate pressure, more wear is done on the instruments than the shaping process which takes less time with lighter pressure. Also, the sterilization procedures tend to dull the instruments, sometimes more than the shaping due to the long cycle time in the autoclave.

A dental tool also includes those useful for teeth cleaning, plaque removal and other periodontal processes, as mentioned above, such as an ultrasonic dental tool typically includes a handpiece coupled at one end (i.e., a proximal end) to an electrical energy source and a fluid source via a cable. The cable includes a hose to provide a fluid (e.g., water), and conductors to provide electrical energy. The other end (i.e., a distal end) of the handpiece has an opening intended to receive a replaceable insert with a transducer (e.g. a magnetostrictive transducer or a piezoelectric transducer) carried on the insert. The transducer extends from the proximal end of the insert into a hollow interior of the handpiece. A tip extends from a distal end of the insert.

Perioscopes and other visual aids are also used in the vicinity of an ultrasonic tip and may also experience ultrasonic energy, even if indirectly.

A vibratory instrument includes a housing having, for example, at least a portion of the housing serving as a handle for grasping by the dental professional. The instrument includes a vibrational mechanism located within a handle portion adapted to induce motion of a scaler tip with respect to the handle, or a portion thereof. The motion of the scaler tip may include a variety of oscillatory modes including flexural and elastic linear modes and torsional modes.

Some tips are bent, either slightly or substantially. If the tip is coated with a coating, the bending will either be done prior to or after coating. When the bending occurs prior to coating, then the coating process may have to take place at a temperature that is not likely to affect the shape of the tip. If the bending takes place after the coating, then the coating may have to be sufficiently flexible so that the bending action does not damage the integrity of the coating or the bend is located in an uncoated portion of the tip.

Some inserts are also made with hand grips to facilitate the gripping of the instruments during use. The hand grip may be made of soft material including a polymeric material for more comfort grip. Some may be made of high temperature resins, which may or may not be soft, suitable for autoclaving or heat sterilization processes. However, even some high temperature resins that can sustain autoclaving may not be able to withstand the coating temperatures of processes, such as sputtering or high temperature chemical vapor deposition, and may necessitate first coating of the tips before assembly of the hand grips onto the inserts.

In addition, during use, heat is generated due to frictional forces resulting from contact of the tip with the tooth being cleaned. This friction and the ultrasonic vibrations cause the tips to wear out quite quickly, which reduces efficiency of the ultrasonic tip and may cause discomfort or pain to the patient.

The way a dental professional detects whether significant wear has occurred is to examine the tip or the abrading instrument. This is an inherently subjective, inaccurate and difficult process to complete. Thus, the most common way a dental professional determines that a tool, for example, a tip is significantly worn is when they detect that ultrasonic cleaning efficiency is significantly decreased or if the patient complains of discomfort or pain during the procedure.

In addition, when an instrument is worn, a dental professional usually has no way of detecting the wear, except through inspection, as noted above, or through trial and error. This is again inefficient and time consuming.

The present invention provides durable coating to working surfaces that is flexible, can conform to undulating surfaces, such as the abrading or cutting surfaces of dental burs, discs, tapes, endodontic files or dental drills, or may be bent after coating, or if the tip is bent prior to coating, the coating can be done at temperatures low enough not adversely affect the bent structure, even if the coating is present at the location of the bent, or the hand grip, when present, and the coating can undergo a color change when it is worn to indicate wear of the tip or abrading surfaces.

In FIG. 1, an exemplary rotary dental bur is shown. The bur 10 includes a shank 11 having a non-abrading shank portion 12 adapted to be fitted into a dental handpiece (not shown), and an abrading working portion 20 connecting to and extending downwardly from the non-abrading shank portion 12. The abrading working portion 20 includes an abrading surface.

One way of generating an abrading surface is by coating or embedding diamond particles 21 into the working surface of working portion 20 of the substrate shank 11. The abrading particles are in turn coated with a diamond-like carbon coating 22.

Another way of generating an abrading surface is by forming cutting surfaces or edges on the surface of the working portion 20 of the shank 11 which is in turn coated with a diamond-like carbon coating 22.

The shank 11 may be made of any suitable metal, including for example, stainless steel, titanium, titanium alloys such as nickel-titanium and titanium-aluminum-vanadium alloys; aluminum, aluminum alloys; tungsten carbide alloys and combinations thereof. More for example, stainless steel and titanium alloys have good flexibility and resistance to torsional breakage.

As an exemplary embodiment, FIG. 2 shows a diamond bur including, for example, a one piece solid stainless steel construction with micro-precise calibration of shank diameters and true concentricity. This instrument may be used to create a rounded gingival margin suited for porcelain fused to metal restoration, as shown in FIG. 2a, or it may be designed for preparing a rounded margin at or below the gingival line with, for example, a 60 degree finish line, as shown in FIG. 2b, ideal for metal or ceramic crowns, for example. Some may also be designed to leave a 90 degree gingival finish line. These generally have a square internal angle and may be tapered or have parallel axial walls, ideal for full porcelain fused to metal restorations, as shown in FIG. 2c. Others may have modified shoulders, designed to leave, for example, a 90 degree gingival finish line with a rounded internal angle, ideal for full porcelain and porcelain fused to metal restorations, as shown in FIG. 2d. FIG. 2e shows an instrument with a tapered axial wall with an extended chamfer finished line, which is most often used for metal margins. Still others are as exemplified in FIG. 2f, for occlusal and lingual reduction, and may be shaped to conform to the occlusal and lingual surfaces with a convex shape, to provide fast bulk reduction and finishing of these surfaces.

Finishing carbide burs are other examples of rotary burs. Some examples are shown in FIGS. 3a-b. The shank may be made of, for example, a one piece solid tungsten carbide alloy construction with micro-precision calibration of shank diameters. Like diamond burs discussed above, they may also be made in many different shapes and blade configurations, with each shape being designed specifically to perform a certain function in trimming, defining and finishing a composite or ceramic restoration of teeth. Finishing carbides also have substantially perfect concentricity and very sharp blade edges. Unlike diamond burs, these sharp edges promote smooth, vibration-free cutting with light working pressure. Most of them may be used to make final adjustments to porcelain restorations.

FIG. 3b shows an example of a finishing carbide having a “football” or “egg” shape. This shape is ideal for fine finishing of occlusal surfaces, to remove any striations caused by diamond burs.

An abrading disc, as shown in FIG. 4, may include a flexible substrate that may be made of metal or polymer. The surface of the substrate may be coated or embedded with diamond particles 21 or having cutting edges formed thereon. The abrading surface may in turn be coated with a diamond-like carbon coating 22. The substrate is substantially thin, for example, at less than about 5 mils (about 0.13 mm), more for example, less than about 3 mils (about 0.08 mm), even more for example, less than about 2 mils (about 0.05 mm). The abrading disc may be bent or twisted, for example, up to about 100°, more for example, up to about 180° without damage to the integrity of the substrate and/or coating.

An abrading tape, as shown in FIG. 5, includes a thin flexible substrate that may be made of metal or polymer. The exemplary thicknesses for the substrate are similar to the substrate of the dental abrading disc. The surface of the substrate may be coated or embedded with diamond particles 21 or having cutting edges may be, in turn, coated with a diamond-like carbon coating 22. Likewise, the dental tape may, for example, be bent or twisted up to 180° without damage to the integrity of the substrate and/or coating.

A suitable metal for the flexible substrate of the disc or tape may be those suitable also for the shanks of dental burs and also include stainless steel, titanium, titanium alloys such as nickel-titanium and titanium-aluminum-vanadium alloys; aluminum, aluminum alloys; tungsten carbide alloys and combinations thereof, for example. More for example, the materials are stainless steel and titanium alloys having good flexibility.

A suitable non-metal may include a polymeric material, such as a high temperature plastic including a polymeric alloy such as ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference)or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used.

Generally, polymeric materials or composites having high temperature resistance are suitable.

When abrasive particles are used, they are, for example, bonded in as close to a single layer as possible, thus exposing more diamond edges. Materials such as diamond particles may be electroplated with nickel or other similar metals, they may be chemical plasma deposited, such as described in U.S. Pat. No. 5,277,940, or they may be embedded in a nickel or nickel alloy matrix, or embedded or bonded using an adherent layer such as a coating of polyurethane or similar hard polymers, as described in U.S. Pat. No. 5,273,559. An exemplary bonding system is one that promotes superior retention of diamond particles on the burs, discs or tapes and minimizes clogging, to result in a faster, cooler cut and a longer lasting diamond instrument.

When an abrading surface is generated by forming various cutting surfaces or edges onto the substrate shank portion 20, the cutting surfaces or edges may include grooves or thin edges, and may be formed either by grinding, casting or molding, or by micro-replication, especially for moldable metals or polymeric substrates, such as shown in FIGS. 6a and 6b.

FIGS. 6a and b show an endodontic file 20 as it appears inside and outside a root canal. The file includes a handle 22, a shank 24, and a working surface of the shank 24a. The working surface includes cutting edges useful for performing cleaning in a root canal procedure. The working surface may also include abrading particles coated or embedded in the shank as mentioned above. The working surface may additionally be coated with a relatively flexible coating that follows the contour of the working surface for improving the life of the instrument, as noted above.

FIG. 7 shows a dental drill having a shank portion 130 and a drill bit portion 127 including cutting edges 124 and 125. These cutting edges may be coated with a relatively flexible coating (not shown here) that can follow the contours of the edges.

The dental burs, such as diamond burs, are generally configured to be of substantially perfect concentricity in addition to having a good bonding system. They may also be made in a variety of shapes, as noted above, and grit sizes, designed to perform many different techniques on teeth and/or restorations in the restorative process. The grit sizes may include super coarse, coarse, medium, fine, superfine and ultra fine. Each grit size has a different function, from bulk reduction to fine finishing, like sandpaper when used in restoring fine antique furniture. Most dental professionals use anywhere from 6 to 10 different shapes of diamond burs and each also has different preference about the shapes and grit each uses. The dental discs and tapes also have similar functions to burs, and like sandpaper, may also have various grit sizes and shapes. Due to their flexibility, they may be used for hard to reach surfaces such as between teeth.

Heat tends to be generated due to frictional forces during use, as mentioned above. Therefore, a coating having high lubricity will tend to decrease the frictional forces and hence, the heat generated, leading also to reduced patient discomfort during a dental process.

Wear of the rotary instruments occurs similarly and differently for abrading surfaces formed in different ways. For the abrading surfaces formed by embedding or coating diamond particles on substrates, in addition to the dulling of edges or the surfaces of the abrading particles during use, the substrates may erode during use and cause the particles to become lost, and such loss causes the abrading surfaces to lose their abrading function. Both the dulling of the edges and the erosion of particles are enhanced by heat generated during use. Since the abrading surfaces are generally rough, high frictional forces may also lead to the generation of heat which in turn causes more erosion of the substrates. A suitable coating is one that may not only improve the retention of the abrading particles, but also improve the lubricity of the abrading surfaces to lower the frictional force, and hence the heat generated during use. The desirable coating is also of sufficient hardness so that it adds to the abrading property of the diamond particles as well as of sufficient flexibility to conform to the contours of the cutting edges of the diamond particles and the uneven contours of the abrading surfaces to prevent loss of the particles, thus leading to a longer useful life of the instruments.

Wear of the abrading surfaces formed with cutting edges may result in duller edges, similar to the edges of the particles discussed above. Therefore, any coating that is of sufficient hardness to preserve the cutting properties of the edges, has sufficient lubricity to lower the heat generated during use, and is of sufficient flexibility to follow the contour of the cutting edges, may similarly lead to extended life of the burs, discs and tapes, even if the coating maybe softer than the abrading particles.

As mentioned above, dental instruments may include cleaning instruments for teeth cleaning, plaque removal and other periodontal processes. The tip may be in the form of a scaler, or those useful for other periodontal treatments including a perioscope and other visualization aid that may be used in the vicinity of an ultrasonic tip, and thus will experience the ultrasonic energy, even if indirectly.

The tip may be made of metal or plastic, and may include the metals, metallic alloys, polymers and polymeric blends and prepregs mentioned above. Some of them may also have a capability of delivering fluid and/or air.

FIG. 8 illustrates an ultrasonic dental unit including an ultrasonic dental tool 100 attached to an electrical energy and fluid source 1050 via a cable 1020. The cable 1020 includes a conduit for carrying fluid as well as wires for carrying electrical signals from the electrical energy and fluid source 1050 to the dental tool 100. The ultrasonic tool 100 includes a handpiece 200 and an insert 1000 inserted into the handpiece 200.

FIG. 9 illustrates a dental insert 1000 including a tip 1010 at its distal end and an ultrasonic transducer 1080 at its proximal end. The tip 1010 may be coupled to the transducer 1080 via a connecting body 1030, which may take the form of a shaft. The tip 1010 may be coated with a coating 1010a. The tip may be constructed to be removably attached to the connecting body 1030 so that tips may be interchanged depending on the desired application. Further, the tip 1010, when removed, may be disposed or steam autoclaved, or otherwise sterilized, after detaching it from the rest of the ultrasonic dental insert 1000.

FIG. 10 shows an exemplary embodiment of the present invention. An exemplary dental insert 1000 having a tip 1010 at its distal end and an ultrasonic transducer 1080 at its proximal end is shown. The tip 1010 includes a shank with a distal end, a proximal end, and a bend along the shank towards its distal end, as noted above. The tip may have a flexible and durable coating 1010a coated thereon, such that the coated tip may be bent to the desired configuration. This bend may also be introduced before coating and may be present at a location coated with the DLC coating.

FIG. 10a shows an exemplary embodiment of the instrument 1000, such as a scaler, of the present invention. The instrument 1000 includes a handle portion 102 and a tooth contacting portion 1010. In the illustrated embodiment, the tooth contacting portion 1010 is a scaler tip. According to one aspect of the invention, a vibrational mechanism is included within the handle portion 102. The vibrational mechanism is adapted to induce motion of the scaler tip 1010 with respect to the handle 102, or a portion thereof. The motion of the scaler tip 1010 may include a variety of oscillatory modes including flexural and elastic linear modes and torsional modes. The details of a vibratory instrument is disclosed in a U.S. Provisional application No. 60/624,833 entitled, “Dental Instrument” filed on Nov. 3, 2004; and a copending U.S. patent application Ser. No. 11/______ entitled, “Dental Instrument” to be concurrently filed; the contents of both of which are hereby incorporated by reference.

According to one embodiment of the invention, the invention includes a switching device 106 supported by the handle portion 102. The switching device 106 allows a user to activate, and deactivate, the vibrational mechanism disposed within the handle portion 102.

According to one embodiment of the invention, an energy port 108, such as a plug receptacle, may also be supported by the handle portion 102. Energy such as electrical energy, maybe received through the energy port and stored within the handle portion 102 of the dental instrument. In the embodiment shown, the energy port is an electrical plug receptacle adapted to receive a conventional electrical plug.

The dental tip may be present on both the distal end and the proximal end of the instrument (not shown) or it may present on only one end. Furthermore, the handle portion may be tapered toward either the distal end or the proximal end or both, and extending from the tapered end or ends are the dental tips adapted to be used on a patient's teeth or tooth.

The tapered portion may be integrally constructed as part of the handle or it may be constructed separately, by either molding, brazing, threadably connected or any other type of attachment to attach the tip onto either the distal or the proximal end of the handle.

The instrument 1000 may include a cone-shaped portion 1140 permanently attached or removably attached to it with its wider end of the cone-shaped portion, and the dental tip 1010 extending from the narrower end of the cone-shaped portion 114. The dental tip may be permanently attached or removably attached to the narrower end of cone-shape portion 1140. The cone-shape portion 114 has at least a partially hollow body. A vibrator module may be positioned and supported inside the hollow portion of the cone-shape portion 114 (not shown).

The module has a small motor for rotating an eccentric weight to cause a vibration in the tip. A battery may be positioned inside the housing to power the vibrator module to excite the vibratory element. The battery may be disposable or rechargeable.

The tapered portion may further be the cone-shaped portion having a hollow interior. The cone-shaped portion may also be rotatable wherein such rotation also rotates the dental tip so that the tip may be easily repositioned without being taken out of the patient's mouth. The mechanism for rotation is similar to that described in the patent application U.S. Ser. No. 10/735,050, the content of which is incorporated herein by reference.

In some embodiments, the inserts may also made with hand grips 1040 to facilitate the gripping of the instrument during use, as illustrated in FIG. 11. Such hand grips are generally made of high temperature resin suitable for autoclaving or heat sterilization process, including those polymers and composites described above that are suitable for the construction of the polymeric tips. In fact, any high temperature resin that can withstand autoclaving may be used. In one example, the insert may be constructed with the tip and the hand grip already assembled prior to coating the tip with a DLC coating. This process is possible because the low coating temperature of the coating processes approximates that of autoclaving. This gives flexibility in the assembly of the insert.

The hand grip 1040 may be fabricated using thermoplastic elastomers such as SANTOPRENE® available from the Monsanto Company, or those used in the construction of some tips, or any other suitable material, as mentioned before. The hand grip 1040 may be formed through injection molding in some embodiments. In other embodiments, the hand grip 1040 may be a one-piece hand grip, which is mounted in such a way as to have a surrounding relationship with the connecting body 1030, as shown in FIG. 4. In still other embodiments, multi-piece hand grips may be used. By way of an example, a two-piece handgrip may be ultrasonically welded together over the connecting body 103. The hand grip 1040 may have a generally cylindrical shape, or may shape like a pistol, as shown in FIGS. 8 and 12.

The hand grip 1040 may also have a slightly protruding portion 980 on one side at the end of which a light source (e.g., LED) is disposed (not shown). Along its outer surface on the other side of the slightly protruding portion 980, the hand grip 1040 has a contour and has a slightly concave area 1070, enabling it to be easily grasped by a dental practitioner. The hand grip 1040 may also have formed thereon a plurality of bumps 1040a (i.e., striped protrusions as shown in FIG. 11) on its external surface to further facilitate grasping of the device by a dental practitioner. Some may even be ergonomically designed. In the described embodiment, a linear groove (e.g., a passageway) 1100 is formed on the tip 1010 for delivering fluid (e.g., water) and/or air to the gum or tooth of the patient.

The hand grips may also be made with varying diameters for grasping, designed to be used interchangeably throughout the day, coupled with more ergonomically designed handles. The details of varying diameters are described in a copending application, “Dental Instruments with Stress Relief”, application No. 11/______, to be concurrently filed, the content of which is incorporated herein by reference.

FIG. 13 illustrates an exemplary embodiment of the invention including a perioscope having a metal sheath which may be used to slightly retract the gingival tissues away from the tooth, thus providing a direct line-of-sight for the camera to see what is on the subgingival root surface. Users of this scope may generally hold it in one hand for visualization, and may also hold an ultrasonic device in the other hand for cleaning. The tip of the scope may experience ultrasonic energy when used in conjunction with such an ultrasonic tool. The tip may be coated with a flexible and durable coating coated thereon, such that the coated tip may be bent to the desired configuration.

The dental tip 1010 may be made of a non-metal, including the materials mentioned above for the construction of the shank, or a metal. A suitable metal may include those mentioned above in relation to the shanks also. The more desirable materials are stainless steel, titanium alloys, and those having good flexibility and resistance to torsional breakage.

In general, the metal tips may be used for general cleaning, scaling and the like, while the non-metal tips may be used around sensitive gum lines, on expensive restorations such as crowns, bridges, and/or around titanium implants which may be more easily damaged by a metal tip. Whether a metal tip or a non-metal tip is used, heat tends to be generated during use due to frictional forces. Therefore, a coating having high lubricity can generally decrease the frictional forces and hence the heat generated, leading to reduced patient discomfort during the dental process. Suitable coatings that have high lubricity include diamond-like carbon (DLC) coatings including at least about 5 atomic percent of hydrogen.

Carbon has two well known crystalline allotropes, diamond and graphite. Carbon also has various amorphous structures. The strong directional sp³ bonding of diamond gives it unique properties such as the highest hardness, elastic modulus and room temperature thermal conductivity of any known solid. On the other hand, graphite's planar sp² bonding gives it a layered structure with high lubricity. Amorphous carbon can exist in a wide range of sp²/sp³ bonding ratios. Diamond like-carbon (DLC) coatings, or more correctly, amorphous carbon-hydrogen films include a range of amorphous carbon structures and a range of hydrogen concentrations. The variations in sp²/sp³ bonding ratios as well as hydrogen concentrations provide a range of properties for DLC coatings. Table 1 compares the properties of some exemplary diamond, DLC and graphite.

TABLE 1*

| | | Young's | | Thermal |
|---|---|---|---|---|
| Carbon | Density | Modulus | Hardness | Conductivity |
| Form | (g/cm³) | (GPa) | (kg/mm²) | (W/mK) |
| DLC | 1.6-2.8 | 45+ | 800-9000 | 100-1000 |
| Pyrolytic, | 2.1-2.2 | 28-40 | 240-370 | 190-390 |
| Graphite, | | | | (ab directions) |
| oriented | | | | 1-3 |
| | | | | (c direction) |
| Vitreous | 1.5 | 35 | 340 | 4.6 |
| Graphite | 1.7-1.9 | 5-10 | 40-100 | 31 |
| | | | | (lamp black) |
| | | | | 159 |
| | | | | (petrol coke) |
| Diamond | 3.5 | 910-1250 | 5000-10000 | 600-1000 |
| | | | | (Type 1a) |

*See handbook of Carbon, Graphite, Diamond and Fullerenes: Properties, Processing and Application, by Hugh O. Pierson, Noyes Publication, Park Ridge, New Jersey, U.S.A. (1993).

DLC coatings are generally inert with respect to chemical and biological agents. The coatings may be made smooth to extremely smooth, leading to the high lubricity noted, and the hardness can be adjusted from the one end, the hardness of graphite to harder than graphite carbon, and even approaching the other end, the hardness of some diamonds. These variations may be accomplished by adjusting the amount of hydrogen present in the coating. If the correct amount of hydrogen is present, a coating of high lubricity and high hardness, harder than those DLC coatings shown in Table 1, is possible.

These coatings may also have varying degrees of flexibility, enabling them to be easily applied over the abrading surfaces of any of the afore-mentioned exemplary shapes and grit sizes, either generated through coating or embedding of diamond particles or through the formation of sharp cutting edges. The flexibility also enables them to be easily bendable to the same degree as the substrates used in the manufacturing of the instruments, for example, the tips, without damage to the coating. For example, the entire tip may be coated, either prior to or after bending, without having to mask the areas around the bend that may lead to the presence or unwanted or unnecessary interfaces along the shank of the tip.

Many different techniques may be used in generating the coatings, for example, physical vapor deposition, chemical vapor deposition, and laser ablations, as disclosed in U.S. Pat. Nos. 4,987,007, and 5,098,737, the contents of which are incorporated herein by reference. Examples of physical vapor deposition processes include single or dual ion-beam sputtering, magnetron sputtering, and radio frequency sputtering. Examples of chemical vapor deposition include hot-filament, plasma-assisted, direct current, radio frequency, direct current thermal plasma, radio frequency thermal plasma and flame chemical-vapor deposition.

Typical deposition methods, like magnetron sputtering, tend to heat the substrate to high temperatures. Even though substrates like high temperature polymeric substrates and stainless steel substrates do not melt at this high temperature, the mechanical properties of the substrates may undergo degradation to a more or less extent. For example, for the instruments having embedded particles, high deposition temperatures may tend to undesirably affect the bonding of the particles to the substrate by degrading the bonding agents, or polymeric substrates used for the flexible discs and tapes. The more suitable methods involve those that do not heat up the substrates, for example, to more than about 200° C., more for example, to not more than about 150° C., and even more for example, to not more than about 100° C., particularly for polymeric substrates. These methods include ion beam assisted deposition and radio-frequency plasma deposition.

In the exemplary techniques, the conditions of coating may be controlled more precisely. The substrate may be mounted on a stage and ion beams may be used to form the coating from a precursor at the surface. The process is carried out in high vacuum, as described, for example, in U.S. Pat. Nos. 5,474,797 and 5,725,573 (the deposition of a DLC coating onto metal or ceramic substrates via the use of ion beam assisted deposition), and a stainless steel or glass chamber is generally used for ion beam assisted deposition.

When applied to surfaces formed with embedded or coated diamond particles, the DLC coating may be attached through covalent bonds with the polymeric bonding agents or substrates, leading to improved adhesion of the coating to the substrate. For the surfaces with sharp edges, the surfaces may be cleaned prior to applying the coating to facilitate better adherence. Similarly, when applied to tips constructed of polymers, the DLC coating may be bonded to the polymeric substrate through covalent bonds with the polymeric substrate, leading to improved adhesion of the coating to the substrate. For the tips constructed of metal, it is desirable to clean the surfaces prior to applying the coating to facilitate better adherence. The cleaning process may be any suitable process normally used to prepare metallic surfaces in any coating process, including an ultrasonic cleaning process.

An organic precursor is generally used to form the DLC coating in the ion beam assisted deposition approach. Suitable organic precursors may include compounds having low vapor pressures at room temperature and thus may be vaporized without breaking down at temperature ranges of about 150 to about 200° C. Those having these properties include carbon based diffusion pump oils, such as polyphenylether, polydimethylsiloxane, pentaphenyltrimethysiloxane and certain naphthalene derivatives. They may be condensed onto surfaces to be coated, for example, by evaporating them near the substrate surfaces. This condensation is done simultaneously with the bombardment of the surface with an ion beam to fragment the precursor molecules. This process releases hydrogen or others from the composition. In general, the ionization fragments at least about 80% of the carbon-hydrogen bonds to form DLC coatings.

A typical ion beam usually generates ions having energies between, for example, about 5 keV and 100 keV, more for example, from about 3 kev to about 25 kev. Generally, a lower beam voltage generates a coating with a higher concentration of hydrogen content, and a higher beam voltage generates a coating with lower hydrogen content. The rate of ion bombardment may be correlated with the rate of precursor delivery, in addition to being dependent on the identity of the ions and precursors and the processing conditions. For stronger bonds to the substrates, the DLC coating may, for example, be chemically bonded to the polymeric bonding agents or the substrates.

Suitable coatings produced by the above mentioned methods may include DLC coatings having, for example, between about 5 atomic percent hydrogen to about 45 atomic percent, and more for example, from about 10 to about 30 atomic percent hydrogen. Generally, higher percentages of hydrogen may be used for more flexible substrates or tips having more flexible shanks, and lower percentages of hydrogen for substrates with less flexibility or tips having less flexible shanks. Those with higher percentage of hydrogen will also be of lower density and softer than those with lower amounts of hydrogen. In addition, smaller amounts of other elements may also be present. For example, the DLCs may include up to about 5 atomic percent of oxygen or nitrogen as well as small quantities of other materials.

As noted above, the DLC coatings, though hard, may be flexible so that the flexural properties of the substrate shank will not be significantly altered by the coatings.

In addition, the flexibility of the coating may enhance the retention of embedded or coated diamond particles by following the contours of the edges. At the same time, the hardness of the DLC coating also makes it suitable to serve as a working surface. The combined effect is a longer lasting abrading surface. Even the coatings that are lighter and softer may also prolong the life of the abrading surfaces. This longer lasting effect is also evident for abrading surfaces created by the formation of cutting edges in the substrate, as the flexible coating will also allow it to follow the contours of the cutting edges better to insure a more even coating. Similarly, the hardness of the coating may contribute to the wear of the cutting edges. As noted, the hardness of the DLC coating also makes it suitable to serve as a working surface for the tip. The flexibility of coating will allow it to follow the contours of the tip to insure a more even coating. The combined effect is a longer lasting tip, even for coatings that are softer and

The rotator head 904 may have formed on the inner surface near its proximal end a circular groove 1310, as exemplified in FIG. 10, that may be used to engage the retainer ring 1300. The retainer ring 1300 may be installed in the circular groove 1310, for example, by applying pressure on the retainer ring 1300 to compress it, and releasing it once the retainer ring 1300 has been aligned with the groove 1310. Upon installation, the retainer ring 1300 is locked to and is fixed with respect to the rotator head 904.

After locking the retainer ring 1300 to the groove 1310, the rotator head 904 is coupled with the body 1020 by receiving the distal end of the body 102 into the rotator head opening at its proximal end. The body 102 may have formed at its distal end an engagement portion 1090, which has a radius that is smaller than the radius of the rest of the body 102. At a joint between the engagement portion 1090 and the rest of the body 102 may be formed a circular groove 1500 on an outer surface of the engagement portion 1030. When the engagement portion 1090 is inserted into the rotator head 904, the retainer ring rotatably engages the groove 1500 such that the rotator head 904 is rotatably coupled to the body 102. In other embodiments, the retaining ring may be fixedly coupled to the body 1020 and rotatably coupled to the rotator head 904. prior to or after bending, without having to mask the areas around the bend that may lead to the presence or unwanted or unnecessary interfaces along the shank of the tip.

Many different techniques may be used in generating the coatings, for example, physical vapor deposition, chemical vapor deposition, and laser ablations, as disclosed in U.S. Pat. Nos. 4,987,007, and 5,098,737, the contents of which are incorporated herein by reference. Examples of physical vapor deposition processes include single or dual ion-beam sputtering, magnetron sputtering, and radio frequency sputtering. Examples of chemical vapor deposition include hot-filament, plasma-assisted, direct current, radio frequency, direct current thermal plasma, radio frequency thermal plasma and flame chemical vapor deposition.

Typical deposition methods, like magnetron sputtering, tend to heat the substrate to high temperatures. Even though substrates like high temperature polymeric substrates and stainless steel substrates do not melt at this high temperature, the mechanical properties of the substrates may undergo degradation to a more or less extent. For example, for the instruments having embedded particles, high deposition temperatures may tend to undesirably affect the bonding of the particles to the substrate by degrading the bonding agents, or polymeric substrates used for the flexible discs and tapes. The more suitable methods involve those that do not heat up the substrates, for example, to more than about 200° C., more for example, to not more than about 150° C., and even more for example, to not more than about 100° C., particularly for polymeric substrates. These methods include ion beam assisted deposition and radio-frequency plasma deposition.

In the exemplary techniques, the conditions of coating may be controlled more precisely. The substrate may be mounted on a stage and ion beams may be used to form the coating from a precursor at the surface. The process is carried out in high vacuum, as described, for example, in U.S. Pat. Nos. 5,474,797 and 5,725,573 (the deposition of a DLC coating onto metal or ceramic substrates via the use of ion beam assisted deposition), and a stainless steel or glass chamber is generally used for ion beam assisted deposition.

When applied to surfaces formed with embedded or coated diamond particles, the DLC coating may be attached through covalent bonds with the polymeric bonding agents or substrates, leading to improved adhesion of the coating to the substrate. For the surfaces with sharp edges, the surfaces may be cleaned prior to applying the coating to facilitate better adherence. Similarly, when applied to tips constructed of polymers, the DLC coating may be bonded to the polymeric substrate through covalent bonds with the polymeric substrate, leading to improved adhesion of the coating to the substrate. For the tips constructed of metal, it is desirable to clean the surfaces prior to applying the coating to facilitate better adherence. The cleaning process may be any suitable process normally used to prepare metallic surfaces in any coating process, including an ultrasonic cleaning process.

An organic precursor is generally used to form the DLC coating in the ion beam assisted deposition approach. Suitable organic precursors may include compounds having low vapor pressures at room temperature and thus may be vaporized without breaking down at temperature ranges of about 150 to about 200° C. Those having these properties include carbon based diffusion pump oils, such as polyphenylether, polydimethylsiloxane, pentaphenyltrimethysiloxane and certain naphthalene derivatives. They may be condensed onto surfaces to be coated, for example, by evaporating them near the substrate surfaces. This condensation is done simultaneously with the bombardment of the surface with an ion beam to fragment the precursor molecules. This process releases hydrogen or others from the composition. In general, the ionization fragments at least about 80% of the carbon-hydrogen bonds to form DLC coatings.

A typical ion beam usually generates ions having energies between, for example, about 5 keV and 100 keV, more for example, from about 3 kev to about 25 kev. Generally, a lower beam voltage generates a coating with a higher concentration of hydrogen content, and a higher beam voltage generates a coating with lower hydrogen content. The rate of ion bombardment may be correlated with the rate of precursor delivery, in addition to being dependent on the identity of the ions and precursors and the processing conditions. For stronger bonds to the substrates, the DLC coating may, for example, be chemically bonded to the polymeric bonding agents or the substrates.

Suitable coatings produced by the above mentioned methods may include DLC coatings having, for example, between about 5 atomic percent hydrogen to about 45 atomic percent, and more for example, from about 10 to about 30 atomic percent hydrogen. Generally, higher percentages of hydrogen may be used for more flexible substrates or tips having more flexible shanks, and lower percentages of hydrogen for substrates with less flexibility or tips having less flexible shanks. Those with higher percentage of hydrogen will also be of lower density and softer than those with lower amounts of hydrogen. In addition, smaller amounts of other elements may also be present. For example, the DLCs may include up to about 5 atomic percent of oxygen or nitrogen as well as small quantities of other materials.

As noted above, the DLC coatings, though hard, may be flexible so that the flexural properties of the substrate shank will not be significantly altered by the coatings.

In addition, the flexibility of the coating may enhance the retention of embedded or coated diamond particles by following the contours of the edges. At the same time, the hardness of the DLC coating also makes it suitable to serve as a working surface. The combined effect is a longer lasting abrading surface. Even the coatings that are lighter and softer may also prolong the life of the abrading surfaces. This longer lasting effect is also evident for abrading surfaces created by the formation of cutting edges in the substrate, as the flexible coating will also allow it to follow the contours of the cutting edges better to insure a more even coating. Similarly, the hardness of the coating may contribute to the wear of the cutting edges. As noted, the hardness of the DLC coating also makes it suitable to serve as a working surface for the tip. The flexibility of coating will allow it to follow the contours of the tip to insure a more even coating. The combined effect is a longer lasting tip, even for coatings that are softer and lighter, as shown in Table 1.

Generally, because the DLC coatings are flexible and lubricious, a substantially uniform thickness may be achieved even at thin coatings of, for example, about 20 nm. A DLC coating may be applied substantially uniformly over a desired section of the substrate. More for example, a uniform coating may be a coating in which the thickness at all points along the substrate varies by, for example, less than about 50%, and more for example, by less than about 10% relative to the average coating thickness. Of course, since the DLC coating only covers the working or abrading portion of the shank, the edge of the coating forms a discontinuity and the presence of such an edge is not considered to result in a non-uniform coating. If the DLC coating only covers the working portion of a tip, then the edge of the coating forms a discontinuity and the presence of such an edge is not considered to result in a non-uniform coating.

Alternatively, the DLC coating may also be applied non-uniformly so that the thickness of the coating may vary at different regions of the working surface, if desired. In some embodiments, the area with the maximum coating thickness may be no more than a factor of about two (2) thicker than the area with the minimum coating thickness. A non-uniform coating thickness can accomplish a variety of goals that a uniform coating cannot, for example, simplifying deposition, and/or adding mechanical stability to stress points of the abrading surfaces or the tip. Generally, because the DLC coatings are flexible and lubricious, a substantially uniform thickness may be achieved even at thin coatings of, for example, about 20 nm.

The DLC coating may be thicker at portions of the abrading surface that are expected to be subjected to high stress or wear to provide increased wear resistance. In addition, a chosen deposition approach may inherently produce a DLC coating that is non-uniform in thickness unless significant efforts are made to reduce the non-uniformity.

The DLC coating may also be thicker at portions of the tip that maybe expected to be subjected to high stress or wear to provide increased wear resistance. For example, the extended portion in the bend may have a thicker coating than the compressed portion, to keep the shape of the bend. In addition, a chosen deposition approach may inherently produce a DLC coating that is non-uniform in thickness unless significant efforts are made to reduce the non-uniformity.

The composition of a DLC coating may also be either uniform or different at different regions of the coating. For example, regions that are subject to more stress may have one particular composition while other portions of the coating may be formed with other dopants, for example, to vary the flexibility. Similarly, the DLC coating may have layers of diamond-like carbon with different compositions.

Exemplary coating thicknesses may range from about 50 nm to about 100 microns, more for example, from about 100 nm to about 20 microns, and even more for example, from about 250 nm to about 10 microns. Apart from the influence of chemical composition, the flexibility is also dependent on the thickness of the coating. The thicker the coating, the less flexible the coating is, and the more intense the color, assuming the same composition is used.

In addition, the flexibility of the coating can give flexibility to the manufacturing process of the dental inserts, such as the ability to coat the entire tip rather than having to mask the location of the tip where the bend is or will be placed. For the inserts having a tip that is bent, either slightly or substantially, the bent may be introduced either prior to the DLC coating or after the coating has been accomplished. If the bending takes place after the coating, the flexible coating can endure such bending action without compromising the integrity of the coating in a substantial manner. When the bending occurs prior to coating, then the low temperature coating process will not substantially affect the bend or the shape of the tip.

For a perioscope, such as that shown in FIG. 13, the coating may take place either before or after the assembly of the scope.

In addition to improving the durability of the instruments, the coating may also act as a wear indicator of the abrading surfaces or the tips. Thicker coatings tend to be of a dark color to a black color and thinner coatings tend to be more transparent to ultraviolet, visible and/or infrared light. In general, to act as a visual wear indicator, a darker color, hence a thicker coating is desirable, but not too thick as to interfere with the abrading surface underneath the coating. For example, the DLC coating is different in color from the substrate including the non-abrading shank, the abrading surface formed with cutting edges or surfaces, or the color of the abrading surface coated or embedded with diamond particles, and the color change anywhere on the abrading portion may act as a wear indicator of the abrading portion.

In general, to act as a visual wear indicator, a darker color, hence a thicker coating is desirable, but not too thick so as to interfere with the function of the tip or abrading surface. For example, the DLC coating is different in color from the working portion of the substrate of the tip such that the color change anywhere on the working portion may act as a wear indicator of the tip.

Although the change in color does not necessarily mean that the abrading surface will instantly stop functioning, it does indicate that the end of the life of the abrading surface is approaching, and therefore the dental professional is alerted to replace the bur before starting work on the next patient. This may save time and resources and contributes to patient comfort since a dull instrument not only does unproductive work, but it may also add to unwanted trauma to the patient. Therefore, besides fulfilling the challenge of providing longer lasting instruments and knowing before an instrument is about to fail, there is also benefit in having better cutting efficiency, accuracy, performance, etc. with the DLC coating.

The embodiments described above are intended to be illustrative and not limiting. It will be appreciated by those of ordinary skill in the art that other embodiments of the present invention are possible without departing from the spirit or essential character of the invention hereof. The scope of the present invention is indicated by the appended claims, and all changes that come within the meaning and range of equivalents thereof are intended to be embraced therein.

1. A dental instrument comprising a substrate having a working surface, and coated on said working surface of said substrate is a flexible coating comprising a diamond-like carbon coating comprising at least about 5 atomic percent of hydrogen.

2. The dental instrument of claim 1 wherein said instrument is selected from the group consisting of rotary dental burs, dental discs, tapes, endodontic files, dental scalers, surgical drills and taps.

3. The dental instrument of claim 2 wherein said dental discs or tapes comprises a flexible substrate.

4. The dental instrument of claim 3 wherein said dental instrument is capable of being bent at least about 100° without damage to the integrity of the coating.

5. The dental instrument of claim 3 wherein said dental instrument is capable of being bent up to about 180° without damage to the integrity of the coating.

6. The dental instrument of claim 2, wherein said rotary dental bur comprises a shank of a relatively hard substrate, said shank having a non-abrading portion and an abrading working portion comprising said flexible coating.

7. The dental instrument of claim 1 wherein said abrading working surface comprises embedded or coated diamond particles onto the substrate.

8. The dental instrument of claim 7 wherein said diamond particles are embedded or coated using a material selected from the group consisting of polymeric bonding agents, nickel matrices, nickel alloy matrices and mixtures thereof.

9. The dental instrument of claim 1 wherein said abrading working surfaces comprises cutting edges or surfaces formed on the surface of the substrate.

10. The dental instrument of claim 1 wherein the flexible coating has a different color from the surface of the abrading portion without the flexible coating.

11. The dental instrument of claim 1 wherein the flexible coating is present on the surface of the substrate that comes into contact with a work piece during use without obstructing the abrasive function of the surface.

12. The dental instrument of claim 1 wherein said flexible coating is coated onto the abrading surface of the substrate using a method selected from a group consisting of ion beam assisted deposition and radio-frequency plasma deposition.

13. The dental instrument of claim 1 wherein said flexible coating comprises between about 5 to about 45 atomic percent of hydrogen.

14. The dental instrument of claim 1 wherein said flexible coating comprises between about 10 to about 30 atomic percent of hydrogen.

15. The dental instrument of claim 1 wherein said diamond-like carbon coating comprises amorphous atomic structures, microcrystalline atomic structures or combinations thereof.

16. The dental instrument of claim 1 wherein said working surface comprises an abrading portion connects to and extends downwardly from a non-abrading portion, said abrading portion having a different color from the non-abrading portion such that the color change anywhere on the abrading portion acts as a wear indicator of the abrading portion.

17. The dental instrument of claim 16 wherein said diamond-like carbon coating has a different color from the underlining working surface coated with diamond particles.

18. The dental instrument of claim 16 wherein said diamond-like carbon coating closely follows the contours of the abrading surface such that said substrate remains substantially covered by the coating during use.

19. The dental instrument of claim 16 wherein said flexible diamond-like carbon coating is of a substantially uniform thickness throughout the abrading portion.

20. The dental instrument of claim 16 wherein said flexible diamond-like carbon coating has varying thicknesses throughout the abrading portion.

21. The dental instrument of claim 20 wherein an area with a maximum coating thickness is of no more than a factor of about two (2) from an area with a minimum coating thickness.

22. A dental tip comprises a substrate shank having a flexible and durable coating coated thereon at least a portion of the substrate shank, wherein the coated tip has a desired bent configuration, and said coating comprises a diamond-like-carbon (DLC) coating comprising at least about 5 atomic percent of hydrogen.

23. The dental tip of claim 22 wherein the tip comprises a part of an ultrasonic dental insert or a vibratory instrument comprising a proximal end, and a distal end having the tip attached thereto.

24. The dental tip of claim 22 wherein said dental insert may be inserted into a handpiece having a polymeric hand grip attached thereon.

25. The dental tip of claim 22 wherein said DLC coating comprises from about 10 to about 30 atomic percent of hydrogen.

26. The dental tip of claim 22 wherein said substrate shank is constructed from a material selected from the group consisting of metal, polymer and mixtures thereof.

27. The dental tip of claim 22 wherein said bent configuration of the tip is introduced after the DLC coating is coated on the substrate.

28. The dental tip of claim 22 wherein said bent configuration of the tip is introduced prior to coating the substrate with the DLC coating.

29. The dental tip of claim 22 wherein the wherein the vibratory instrument includes an elongated housing having a hollow interior with a vibrator module positioned inside the hollow interior comprising a small motor adapted for rotating an eccentric weight to cause a vibration in the tip.

30. The dental tip of claim 22 wherein the diamond-like carbon coating is different in color from the substrate such that the color change anywhere on the tip acts as a wear indicator of the tip.

31. The dental tip of claim 22 wherein said tip comprises a part of a perioscope.

32. An ultrasonic dental insert comprising a proximal end, and a distal end having a tip attached thereto, a polymeric hand grip covering a portion of the insert proximate the distal end of the insert, said tip comprising a substrate shank having a flexible and durable coating coated thereon at least a portion of said substrate after the insert and hand grip are assembled, wherein said coating comprises a diamond-like-carbon coating comprising at least about 5 atomic percent of hydrogen.

33. The ultrasonic dental insert of claim 32 wherein said tip is bent prior to the coating.

34. The ultrasonic dental insert of claim 32 wherein said tip is bent after the coating is applied.

35. The ultrasonic dental insert of claim 32 wherein said flexible coating comprises from about 10 to about 30 atomic percent of hydrogen.

36. The ultrasonic dental insert of claim 32 wherein the DLC coating is different in color from the substrate such that the color change anywhere on the tip acts as a wear indicator of the tip.

37. A method of producing an ultrasonic dental insert comprising a tip having a flexible and durable coating coated thereon comprising:
assembling an insert having a tip at its distal end; and
coating at least a portion of the tip with a flexible and durable coating at a temperature that does not substantially affect the substrate of the tip;
wherein the coating comprises a diamond-like-carbon coating comprising at least about 5 atomic percent hydrogen.

38. The method of claim 37 wherein the tip is bent to any desired configuration after coating.

39. The method of claim 37 wherein the tip is bent to any desired configuration prior to coating.

40. The method of claim 37 wherein said insert is assembled prior to coating.
